(19) United States
(12) Patent Application Publication
(10) Pub. No.: US 2026/0323236 A1
(43) Pub. Date: Oct. 15, 2026

(54) PATHFINDING FOR AUDIO OCCLUSION AND DIFFRACTION IN VIRTUAL ENVIRONMENTS

(71) Applicant: Roblox Corporation, San Mateo, CA (US)

(72) Inventor: Palmer Noel HOGEN, Glendale, CA (US)

(73) Assignee: Roblox Corporation, San Mateo, CA (US)

(21) Appl. No.: 19/643,521

(22) Filed: Apr. 9, 2026

Related U.S. Application Data
(60) Provisional application No. 63/786,955, filed on Apr. 10, 2025.

(51) Int. Cl. H04S 7/00; G06T 15/08

(52) U.S. Cl. CPC H04S 7/303; G06T 15/08; H04S 2400/11; H04S 2400/13

(57) ABSTRACT

Some implementations relate to methods, systems and computer readable media for simulating audio occlusion and diffraction in a three-dimensional virtual environment. According to one aspect, a voxel grid centered at a sound emitter is constructed, each voxel corresponding to a volume in the 3D virtual environment. A respective density value is computed for each voxel based on intersection with geometry using a physics data structure. A shortest-path search is performed to determine a path from a voxel including the sound emitter to a voxel including a listener. An arrival direction is determined based on a final segment of the path. Directional panning or amplitude attenuation is adjusted based on the arrival direction and cumulative density values along the path, and the audio is rendered at the listener.

### CROSS-REFERENCE TO RELATED APPLICATIONS

This application claims priority to U.S. Provisional Patent Application No. 63/786,955, filed Apr. 10, 2025, and titled “PATHFINDING FOR AUDIO OCCLUSION AND DIFFRACTION IN VIRTUAL ENVIRONMENTS,” the entire contents of which are incorporated by reference herein.

### TECHNICAL FIELD

This document relates generally to audio rendering in virtual environments, and more particularly but not exclusively, relates to methods, systems, and computer-readable media to provide pathfinding for audio occlusion and diffraction in virtual environments.

### BACKGROUND

Real-time audio rendering in virtual environments lacks techniques that accurately model how sound behaves when obstructed by geometry. Audio engines use direct line-of-sight raycasting to determine whether a sound source is audible to a listener and to adjust attributes such as volume and stereo positioning. These techniques fail to account for diffraction around obstacles and transmission through partially obstructed regions. As a result, the rendered audio lacks cues that reflect how sound interacts with the surrounding environment, leading to unrealistic spatial perception in applications such as gaming, simulation, and virtual collaboration.

Some approaches attempt to approximate indirect sound behavior through static configuration. These include manually authored portals between rooms or precomputed acoustic graphs. In these approaches, the acoustic connectivity of spaces is defined ahead of time, enabling indirect paths between sound sources and listeners. However, the configurations require manual setup and are not compatible with dynamic or procedurally generated environments where geometry changes during runtime. Static precomputation fails to handle transient occlusions or geometry variations that arise during interactive experiences.

Wave-based techniques that simulate physical sound propagation using numerical methods can model phenomena such as audio diffraction and occlusion with high fidelity. The techniques solve approximations of the wave equation over the environment geometry. However, the computational cost of such simulations exceeds the performance budgets of interactive applications. Real-time environments with large or changing geometry cannot support the techniques without unacceptable latency or resource usage. As a result, physical simulation is not viable for scalable, interactive audio rendering in most virtual environments.

Some approaches adapt volumetric ray-based techniques from graphics rendering to model sound behavior through casting, shadowing, and reflection. The techniques rely on efficient data structures and are suited for line-of-sight calculations. However, they fail to account for how sound bends or transmits in obstructed regions. Some volumetric pathfinding techniques attempt to find routes for audio in 3D space by evaluating connectivity between a sound source and a listener. The techniques explore candidate paths across a grid of volume elements. In high-dimensional search spaces with large branching factors, these approaches consume excessive memory and compute resources and produce degraded responsiveness under constrained execution.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Various implementations described herein relate to methods, systems, and computer-readable media to provide pathfinding for audio occlusion and diffraction in virtual environments.

According to one aspect, a computer-implemented method includes constructing a voxel grid centered at a sound emitter in a 3D virtual environment, where the voxel grid includes a plurality of voxels and each voxel in the voxel grid corresponds to a respective volume in the 3D virtual environment. A respective density value is computed for each voxel based on intersection with geometry in the 3D virtual environment using a physics data structure that represents the geometry. A shortest-path search is performed to determine a path from a first voxel that includes the sound emitter to a second voxel that includes a listener in the 3D virtual environment. An arrival direction is determined for audio emitted by the sound emitter based on a final segment of the path. At least one of directional panning or amplitude attenuation of the audio emitted by the sound emitter is adjusted based on the arrival direction and cumulative density values along the path. After the adjusting, the audio at the listener is rendered.

In some implementations, it is determined whether a direct line of sight exists between the sound emitter and the listener, where the adjusting is performed in response to absence of the direct line of sight.

In some implementations, determining the path comprises: detecting that a computational resource constraint is met during the performing the shortest-path search; and in response to detecting that the computational resource constraint is met, completing the path with a straight-line segment to the listener.

In some implementations, performing the shortest-path search includes minimizing a cost function including distance multiplied by voxel density.

In some implementations, performing the shortest-path search is executed on a program thread that is decoupled from a rendering frame loop that executes the rendering of the audio. In some implementations, constructing the voxel grid is performed incrementally during the performing of the shortest-path search as voxels are visited during the shortest-path search. In some implementations, computing the respective density value for each voxel includes: querying collision or material data from the physics data structure; and assigning the density value based on collision or material properties of geometry intersecting the voxel. In some implementations, incrementally constructing the voxel grid includes: computing axis-aligned neighboring voxels of a current voxel; computing a respective density value for each of the axis-aligned neighboring voxels based on intersection with geometry in the 3D virtual environment; and extending the path to include one of the axis-aligned neighboring voxels based on the density values of the axis-aligned neighboring voxels.

In some implementations, the shortest-path search includes a weighted A* search that evaluates candidate voxels using an evaluation function including a path cost from the sound emitter to a current voxel and a heuristic estimate from the current voxel to the listener, where the heuristic estimate is multiplied by a weight greater than one. In some implementations, the weight is adjusted dynamically based on a time threshold, where adjusting the weight modifies a relative contribution of a path cost from the sound emitter to a current voxel and a heuristic estimate from the current voxel to the listener during the weighted A* search.

In some implementations, cumulative density values along the path are used to adjust one or more audio rendering parameters including the directional panning or the amplitude attenuation, where higher cumulative density values correspond to higher attenuation of audio rendered at the listener. In some implementations, the one or more audio rendering parameters include an amplitude attenuation factor applied to the sound emitter at the listener.

According to another aspect, a computing device includes one or more processors, and memory coupled to the one or more processors with instructions stored thereon that, when executed by the one or more processors, cause the one or more processors to perform or control performance of operations including constructing a voxel grid centered at a sound emitter in a 3D virtual environment, where the voxel grid includes a plurality of voxels and each voxel in the voxel grid corresponds to a respective volume in the 3D virtual environment. A respective density value is computed for each voxel based on intersection with geometry in the 3D virtual environment using a physics data structure that represents the geometry. A shortest-path search is performed to determine a path from a first voxel that includes the sound emitter to a second voxel that includes a listener in the 3D virtual environment. An arrival direction is determined for audio emitted by the sound emitter based on a final segment of the path. At least one of directional panning or amplitude attenuation of the audio emitted by the sound emitter is adjusted based on the arrival direction and cumulative density values along the path. After the adjusting, the audio at the listener is rendered.

In some implementations, the directional panning is performed using vector-base amplitude panning based on the arrival direction.

In some implementations, the operations are performed individually for each sound emitter such that performance of the operations for a first sound emitter that is closer to the listener than a second sound emitter is prioritized over performance of the operations for the second sound emitter.

In some implementations, the operations are performed individually for each sound emitter, and a frequency of path updates for a first sound emitter that is closer to the listener than a second sound emitter is higher than a frequency of path updates for the second sound emitter.

In some implementations, the instructions cause the one or more processors to perform or control performance of a further operation including performing a beam search during the shortest-path search, where the beam search utilizes a min-max heap to prune voxels based on a computational cost threshold.

In some implementations, the voxel grid has a hierarchical structure, and constructing the hierarchical structure includes using a larger voxel size for volumes of the 3D virtual environment that do not include the geometry and a smaller voxel size for volumes of the 3D virtual environment that include the geometry.

In some implementations, the instructions cause the one or more processors to perform or control performance of a further operation including determining whether a direct line of sight exists between the sound emitter and the listener, where the adjusting is performed in response to absence of the direct line of sight.

According to another aspect, a non-transitory computer-readable medium includes instructions stored thereon that, when executed by a processor, cause the processor to perform or control performance of operations including constructing a voxel grid centered at a sound emitter in a 3D virtual environment, where the voxel grid includes a plurality of voxels and each voxel in the voxel grid corresponds to a respective volume in the 3D virtual environment. A respective density value is computed for each voxel based on intersection with geometry in the 3D virtual environment using a physics data structure that represents the geometry. A shortest-path search is performed to determine a path from a first voxel that includes the sound emitter to a second voxel that includes a listener in the 3D virtual environment. An arrival direction is determined for audio emitted by the sound emitter based on a final segment of the path. At least one of directional panning or amplitude attenuation of the audio emitted by the sound emitter is adjusted based on the arrival direction and cumulative density values along the path. After the adjusting, the audio at the listener is rendered.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF DRAWINGS

FIG. 1 is a diagram of an example system architecture to provide pathfinding for audio occlusion and diffraction in virtual environments, in accordance with some implementations.

FIG. 2 is a flow diagram illustrating an example method to provide pathfinding for audio occlusion and diffraction in virtual environments, in accordance with some implementations.

FIG. 3A is a diagram illustrating a rendered scene from a virtual environment in which audio occlusion and diffraction have not been enabled, in accordance with some implementations.

FIG. 3B is a diagram illustrating a rendered scene from a virtual environment in which audio occlusion and diffraction have not yet been enabled, in accordance with some implementations.

FIG. 3C is a diagram illustrating a rendered scene from a virtual environment in which both audio occlusion and diffraction have been enabled, in accordance with some implementations.

FIG. 3D is a diagram illustrating a rendered scene from a virtual environment in which visual debugging for audio pathfinding has been enabled, in accordance with some implementations.

FIG. 3E is a diagram illustrating a view from within an interior space of a virtual environment where audio pathfinding visualization has been enabled, in accordance with some implementations.

FIG. 3F is a diagram illustrating a scene from a virtual environment showing a combination of audio pathfinding visualization and directional arrival indicators, in accordance with some implementations.

FIG. 3G is a diagram illustrating a rendered scene from a virtual environment where multiple audio emitters are active and audio pathfinding visualizations are enabled, in accordance with some implementations.

FIG. 3H is a diagram illustrating a rendered scene from a virtual environment with visual audio pathfinding overlays enabled, showing how path updates adapt in response to listener movement, in accordance with some implementations.

FIG. 4 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various implementations discussed herein enables real-time modeling of sound occlusion and diffraction in dynamic virtual environments by performing pathfinding from a sound emitter to a listener using a voxel grid constructed on demand. Each voxel is assigned a density value derived from runtime geometry using physics data structures, and a weighted shortest-path search is used to find a path that decreases distance multiplied by density. If the search exceeds computational constraints (e.g., total compute capacity such as memory, processing or other resources; latency limits for the computation), a partial path is extended to the listener with a straight-line segment. The resulting path is used to determine the arrival direction and energy loss, which are applied to adjust directional panning and amplitude attenuation. The techniques enable perceptually grounded, directional audio to be rendered efficiently in environments with dynamic or complex geometry.

Some technical advantages of one or more described features include representing a three-dimensional (3D) virtual environment using a voxel grid in which each voxel is assigned a density value based on intersection with geometry represented in a physics data structure. The representation enables path determination to incorporate spatial relationships between sound emitters, listeners, and intervening geometry by associating density values with volumes of space that correspond to collision or material properties.

Another technical advantage of some implementations is performing a shortest-path search over the voxel grid to determine a path between a voxel including a sound emitter and a voxel including a listener. The shortest-path search evaluates candidate paths using a cost function that includes distance and voxel density, enabling traversal through regions of the 3D virtual environment to be quantified using both geometric distance and interaction with geometry represented in the physics data structure.

Another technical advantage of some implementations is using a weighted A* search in which a heuristic estimate is multiplied by a weight greater than one, and dynamically adjusting the weight based on a time threshold. This enables modification of a relative contribution of a path cost and a heuristic estimate during execution of the shortest-path search, enabling control over evaluation of candidate voxels under different computational conditions.

Another technical advantage of some implementations is constructing the voxel grid incrementally during execution of the shortest-path search as voxels are visited. This includes computing axis-aligned neighboring voxels of a current voxel, computing density values for the neighboring voxels based on intersection with geometry, and extending the path based on the density values. The incremental construction limits voxel generation to regions that are traversed during path determination.

Another technical advantage of some implementations is adjusting audio rendering parameters based on an arrival direction determined from a final segment of the path and cumulative density values along the path. Directional panning is determined based on the arrival direction, and amplitude attenuation is determined based on cumulative density values, such that different paths through the voxel grid result in different audio rendering parameters at the listener.

Another technical advantage of some implementations is supporting multiple sound emitters by performing operations individually for each sound emitter and prioritizing processing for sound emitters that are closer to the listener, and by adjusting a frequency of path updates based on distance between each sound emitter and the listener. This enables allocation of computational resources across multiple sound emitters based on spatial relationships within the 3D virtual environment.

### System architecture

The present disclosure is directed towards, inter alia, techniques to provide pathfinding for audio occlusion and diffraction in virtual environments.

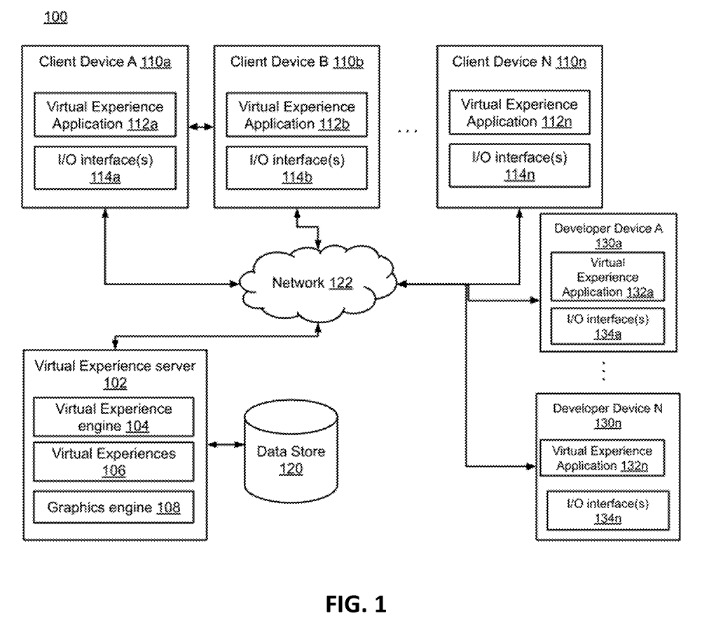

FIG. 1 is a diagram of an example system architecture that can be used to provide pathfinding for audio occlusion and diffraction in virtual environments. FIG. 1 and the other figures use like reference numerals to identify similar elements. A letter after a reference numeral, such as “110," indicates that the text refers specifically to the element having that particular reference numeral. A reference numeral in the text without a following letter, such as "110," refers to any or all of the elements in the figures bearing that reference numeral (e.g. "110" in the text refers to reference numerals “110a," “110b," and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

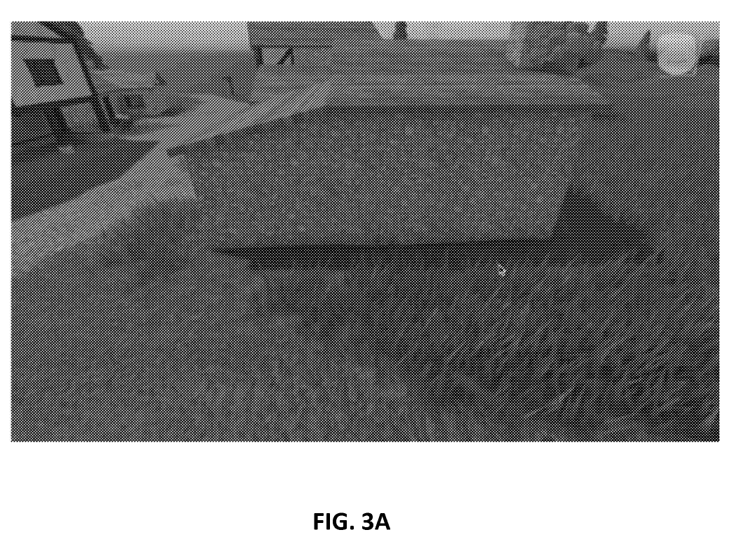

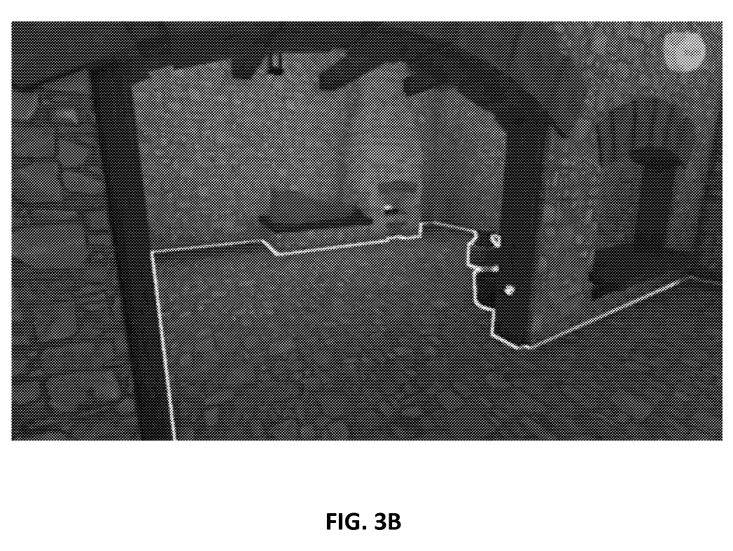

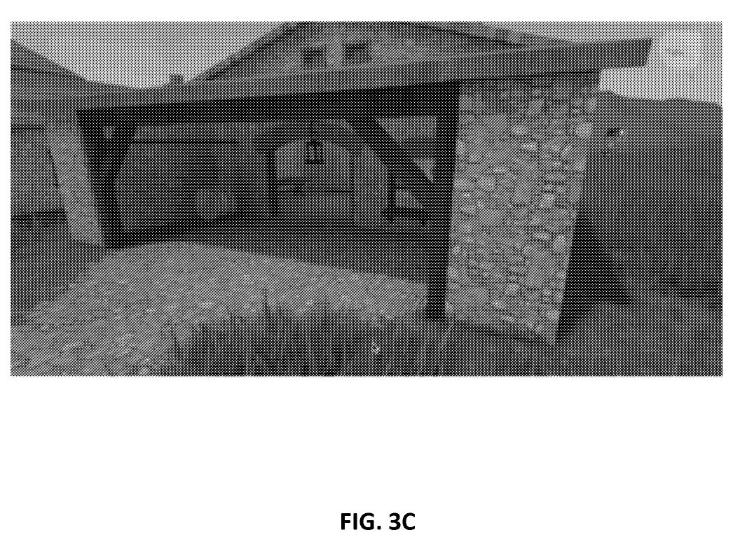

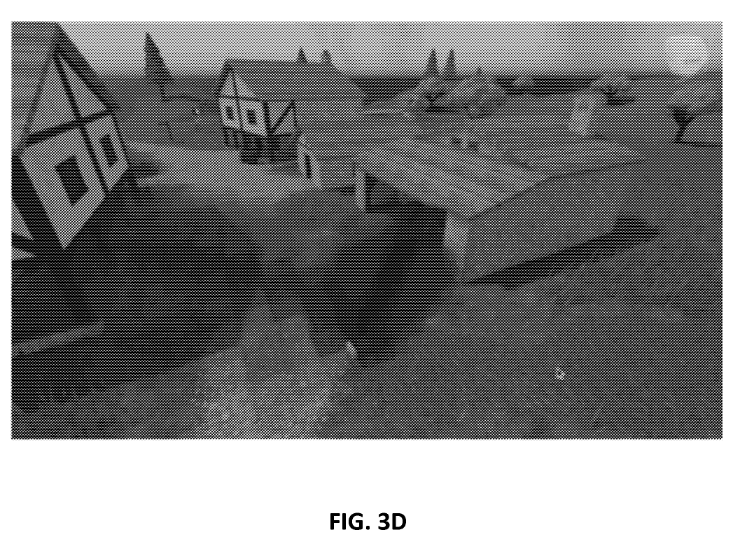

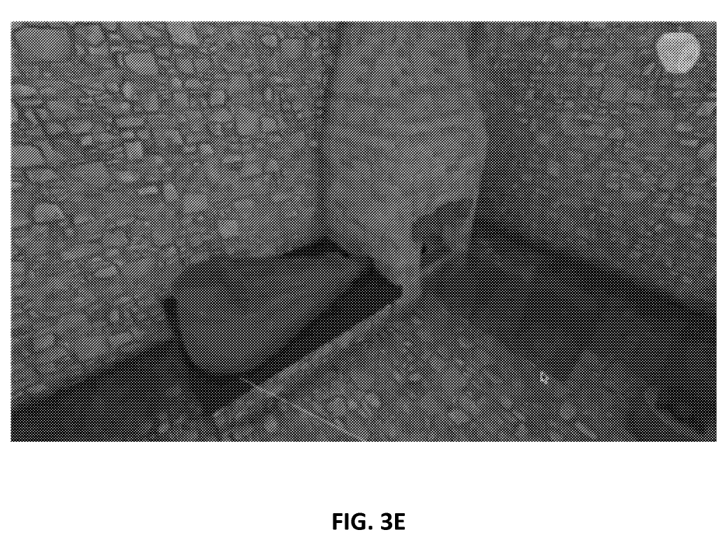

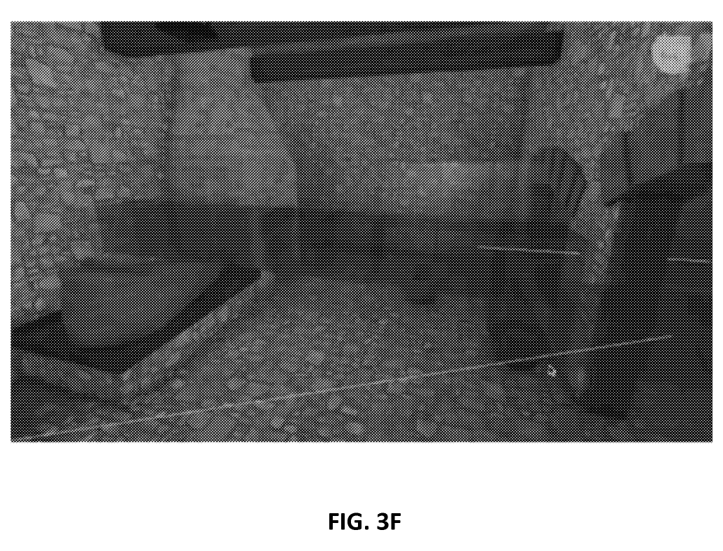

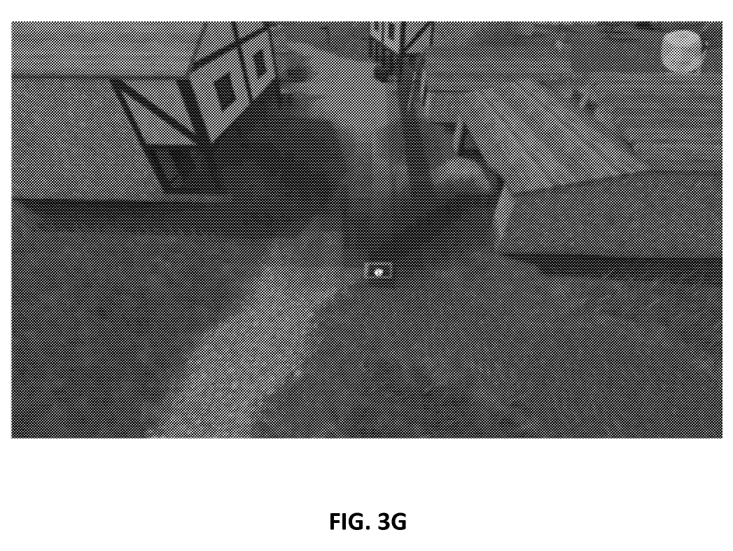

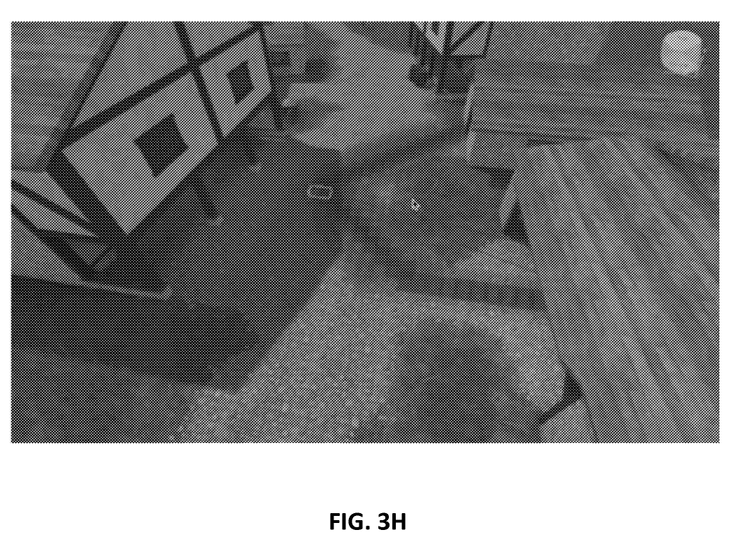

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 3. In one or more additional or alternative implementations, the operations described below may be performed on one or more client devices 110, or one or more developer devices 130. In some implementations, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in near-real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), audio engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (i.e., avatar) of the user within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/ type of body parts; proportion (e.g., shoulder and hip ratio); head size; etc.

One or more characters (also referred to as an “avatar” or “model” herein) may be associated with a user where the user may control the character to enable an interaction of the user with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to enable the interaction of the user with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a character of a user for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, animate or inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a character of a user can include a configuration of components, where the configuration and appearance of components and more generally the appearance of the character may be defined by character settings. In some implementations, the character settings of a character of a user may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

In some implementations, a virtual platform server (e.g., virtual experience engine 104 and/or other component(s) of the virtual experience server 102) includes an audio processing component configured to determine propagation of audio between a sound emitter and a listener within a 3D virtual environment. The audio processing component may apply the techniques described herein, including constructing a voxel grid centered at the sound emitter, computing density values for voxels based on intersection with geometry represented in a physics data structure, and performing a shortest-path search to determine a path through the voxel grid. The component may further determine an arrival direction based on a final segment of the path and adjust one or more audio rendering parameters, including directional panning and amplitude attenuation, based on the arrival direction and cumulative density values along the path. By executing the operations server-side or platform-side, audio propagation behavior can remain consistent across different client devices while reducing computational load on the client.

Client devices (e.g., 110) may execute a platform application, game client, or browser-based interface that receives audio rendering parameters and outputs audio based on those parameters. In some implementations, the client device may provide positional data associated with the sound emitter and the listener, along with updates to geometry or scene state, to the platform, which returns adjusted audio parameters including arrival direction and attenuation values. Alternatively or additionally, the client device may perform one or more of the described operations locally, including constructing the voxel grid, computing density values, and performing the shortest-path search using configuration data or physics data structures provided by the platform. In either configuration, the client device may handle rendering of the audio based on the adjusted parameters while maintaining consistency with the path-based audio propagation determined using the described techniques.

### Providing pathfinding for audio occlusion and diffraction in virtual environments

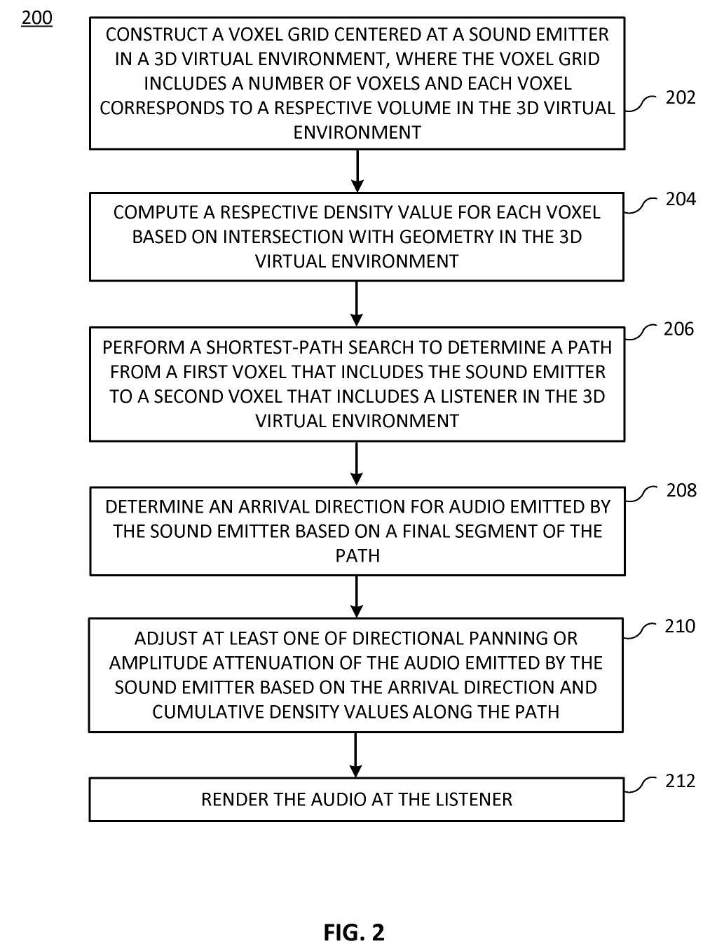

FIG. 2 is a flow diagram illustrating an example method 200 to provide pathfinding for audio occlusion and diffraction in virtual environments, in accordance with some implementations.

In various implementations, the blocks shown in FIG. 2 and described below may be performed by any of the computing devices illustrated in FIG. 1, for example, by one or more of client devices 110 and/or online virtual experience server 102 and/or other device(s) usable in the system architecture 100. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102.

Method 200 begins at block 202. At block 202, a voxel grid centered at a sound emitter in a 3D virtual environment is constructed. The voxel grid includes a number of voxels, and each voxel in the voxel grid corresponds to a respective volume in the 3D virtual environment. The term “volume” as used herein includes a three-dimensional region of space within the 3D virtual environment. A sound emitter includes a source of audio within the 3D virtual environment, such as a virtual object, avatar, or environmental element that produces sound. Examples include a furnace emitting a crackling sound, an anvil producing an impact sound, or a moving object generating mechanical noise. The sound emitter is associated with a position within a coordinate system of the 3D virtual environment.

A voxel grid includes a discretized representation of three-dimensional space, where the space surrounding the sound emitter is partitioned into a plurality of volumetric elements. Each volumetric element includes a voxel, and each voxel includes a bounded three-dimensional region defined by spatial coordinates. In some implementations, voxels are arranged in a regular grid structure aligned with orthogonal axes of the coordinate system, such that each voxel includes a cuboidal region with defined width, height, and depth. In some implementations, the voxel grid is centered at the sound emitter such that the sound emitter is located within a voxel that serves as an origin for path computations.

In some implementations, each voxel includes a spatial extent that maps to a corresponding region of the 3D virtual environment. The spatial extent of a voxel may include a fixed size or may vary, e.g., based on configuration parameters. For example, a voxel may include a cubic region of one meter per side, or another distance unit, depending on the resolution selected for the voxel grid.

In some implementations, the voxel grid is constructed by defining a bounding region around the sound emitter and subdividing the bounding region into voxels. In various implementations, the bounding region may include a spherical region, a cubic region, or another volumetric region centered at the sound emitter. In some implementations, the extent of the bounding region may be determined based on a maximum propagation distance for audio, a listener position, and/or environmental parameters. Voxels are generated within the bounding region such that each voxel includes a portion of the space within the region.

In some implementations, the voxel grid has a hierarchical structure, where constructing the hierarchical structure includes using a larger voxel size for volumes of the 3D virtual environment that do not include the geometry (e.g., empty space of the virtual environment) and a smaller voxel size for volumes of the 3D virtual environment that include the geometry (e.g., space of the virtual environment that includes a virtual object that is constructed as a 3D mesh, a constructive solid geometry, or any other geometric representation). The hierarchical structure includes multiple levels of spatial subdivision, where each level corresponds to a different voxel resolution. In some implementations, volumes of the 3D virtual environment that do not include the geometry are represented using voxels with larger spatial extents, while volumes that include geometry are subdivided into voxels with smaller spatial extents. Determining whether a volume includes geometry includes querying the physics data structure to identify intersections between the volume and geometry in the 3D virtual environment. The hierarchical voxel grid may include parent voxels that are subdivided into child voxels in regions associated with geometry, and the shortest-path search may traverse voxels across different levels of the hierarchical structure.

In some implementations, constructing the voxel grid includes generating neighboring voxels for a current voxel along six axis-aligned directions of the coordinate system of the 3D virtual environment. The six axis-aligned directions include left, right, above, below, forward, and backward directions corresponding to X-axis, Y-axis, and Z-axis movement. Neighboring voxels that are diagonally offset from the current voxel are not generated as part of the construction step. For example, if a current voxel is associated with a first position in the voxel grid, neighboring voxels may be generated at positions offset by a voxel width in a positive or negative X direction, a positive or negative Y direction, or a positive or negative Z direction. In some implementations, the six axis-aligned neighboring voxels are used during incremental construction of the voxel grid and during shortest-path search operations that proceed through the voxel grid. Block 202 is followed by block 204.

At block 204, a respective density value is computed for individual voxels based on intersection with geometry in the 3D virtual environment using a physics data structure that represents the geometry. A density value includes a numerical representation associated with a voxel that characterizes interaction between sound and geometry within a spatial region corresponding to the voxel. The density value may include a scalar value that increases as the amount or type of intersecting geometry within the voxel changes. The density value is associated with the voxel and is used in subsequent path determination and audio rendering operations.

In some implementations, a physics data structure includes a data representation of geometry and physical properties within the 3D virtual environment. The physics data structure includes information associated with objects, surfaces, and materials, such as collision boundaries, mesh representations, and material attributes. Examples of physics data structures include bounding volume hierarchies, spatial partitioning trees, collision meshes, or other structures used by a physics engine to represent geometry for collision detection and spatial queries. The physics data structure provides access to geometric information that is used to determine whether a voxel intersects with one or more objects in the environment.

In some implementations, computing the density value includes performing a spatial query using the physics data structure to identify geometry that intersects with the volume corresponding to a voxel. The spatial query may include determining whether any portion of an object, surface, or material is located within the bounds of the voxel. For example, if a voxel overlaps with a wall, a portion of a building, or a terrain feature, the spatial query identifies the intersecting geometry and retrieves associated properties from the physics data structure.

In some implementations, the density value is computed based on collision properties of intersecting geometry. Collision properties include whether geometry permits or blocks traversal of objects or signals through a region. For example, a voxel that intersects with a solid wall or a dense object may be assigned a higher density value than a voxel that intersects with empty space. A voxel that does not intersect with any geometry may be assigned a density value corresponding to free space. The density values represent differences in interaction between sound and geometry within the environment.

In some implementations, the density value is computed based on material properties associated with geometry intersecting the voxel. Material properties include attributes such as, e.g., composition, surface characteristics, or acoustic properties of objects within the environment. For example, a voxel that intersects with a stone surface may be assigned a different density value than a voxel that intersects with a fabric surface or a transparent material. Material properties obtained from the physics data structure may be mapped to density values using predefined mappings, lookup tables, or computational functions.

In some implementations, computing the density value includes aggregating contributions from multiple pieces of geometry intersecting the voxel. For example, if a voxel intersects with more than one object, the density value may be computed based on a combination of collision properties and material properties of each intersecting object. The aggregation may include summation, weighted combination, or selection of a dominant property associated with the intersecting geometry. The resulting density value is stored in association with the voxel and used in evaluating paths through the voxel grid.

In some implementations, voxel density values are invalidated in response to changes in the physics data structure. Changes in the physics data structure include updates to geometry, object positions, collision boundaries, or material properties within the 3D virtual environment. For example, movement of an object, modification of a structure, creation of a new obstruction, removal of an existing obstruction, or a change in material associated with geometry may alter whether a voxel intersects with geometry or the properties of that geometry. In some implementations, the sound emitter and the listener remain stationary while an object enters or exits a path between the sound emitter and the listener, such as a vehicle, avatar, door, or other object moving into or out of the path, thereby changing geometry represented in the physics data structure. In response to detecting such changes, one or more density values associated with voxels affected by the changes are invalidated. Invalidating a density value includes marking the density value as outdated such that the density value is recomputed during a subsequent operation, including during execution of a shortest-path search or incremental construction of the voxel grid. Block 204 is followed by block 206.

At block 206, a shortest-path search is performed to determine a path from a first voxel that includes the sound emitter to a second voxel that includes a listener in the 3D virtual environment. A shortest-path search includes a computational process that identifies a sequence of connected voxels (e.g., two voxels are connected if they are physically adjacent in the coordinate system of the 3D virtual environment) forming a path between two locations based on a defined cost metric. The first voxel includes the voxel in which the sound emitter is located, and the second voxel includes the voxel in which the listener is located. A listener includes a point in the 3D virtual environment at which audio is rendered, such as a camera position, an avatar position, or another representation of a point of perception of a user.

In some implementations, the shortest-path search operates over the voxel grid by traversing from the first voxel toward the second voxel through neighboring voxels. Each voxel includes connections to a set of neighboring voxels defined by spatial adjacency. For example, a voxel may include neighbors along axis-aligned directions corresponding to left, right, up, down, forward, and backward directions within the coordinate system of the 3D virtual environment. The search progresses by selecting voxels from a set of candidate voxels and expanding to neighboring voxels until a path to the second voxel is identified.

In some implementations, the shortest-path search includes evaluating a cost associated with traversing each voxel. The cost includes a value derived from distance and density values associated with the voxels. For example, traversal through a voxel with a higher density value may contribute a larger cost than traversal through a voxel with a lower density value. The search maintains a cumulative cost for each candidate path, and selects paths based on minimizing the cumulative cost from the first voxel to the second voxel.

In some implementations, the shortest-path search includes maintaining a set of candidate voxels and a set of visited voxels. The set of candidate voxels includes voxels that are under consideration for expansion, and the set of visited voxels includes voxels that have already been processed. A priority structure may be used to select a voxel from the set of candidate voxels based on an evaluation function that incorporates cumulative cost and an estimate of remaining cost to reach the second voxel. The search iteratively processes voxels until the second voxel is reached or until a termination condition is met.

In some implementations, the shortest-path search includes a weighted A* search. The weighted A* search evaluates candidate voxels using an evaluation function that includes a path cost from the first voxel to a current voxel and a heuristic estimate from the current voxel to the second voxel. The heuristic estimate includes an estimate of remaining distance between the current voxel and the second voxel. A weight may be applied to the heuristic estimate to influence selection of candidate voxels during the search. Adjusting the weight changes the relative contribution of the heuristic estimate in the evaluation function.

In some implementations, the shortest-path search includes terminating the search when a computational resource constraint is detected. The computational resource constraint may include a limit on processing time (and/or a latency limit associated with audio rendering), number of voxel evaluations, or another threshold associated with execution of the search. When the constraint is detected, a partial path may be identified based on a current voxel, and the path may be completed by connecting the current voxel to the second voxel using a straight-line segment. The resulting path includes both the sequence of voxels identified during the search and the straight-line segment to the listener.

In some implementations, it is determined whether a direct line of sight exists between the sound emitter and the listener. A direct line of sight includes an unobstructed path between a position of the sound emitter and a position of the listener within the 3D virtual environment. Determining whether the direct line of sight exists may include performing a raycast or other visibility query using the physics data structure to detect whether geometry intersects a line extending between the sound emitter and the listener. If geometry intersects the line, the direct line of sight is absent. In response to absence of the direct line of sight, one or more audio adjustments described herein are applied, including adjustment of directional panning or amplitude attenuation based on the arrival direction and cumulative density values along the path. If the direct line of sight exists, the audio may be rendered without applying one or more of the adjustments associated with obstruction of the path between the sound emitter and the listener.

In some implementations, determining the path includes detecting that a computational resource constraint is met during performing of the shortest-path search. A computational resource constraint includes a limit associated with execution of the shortest-path search, such as a maximum processing time, a maximum number of voxel evaluations, or a threshold number of iterations. During execution of the shortest-path search, a current voxel is identified based on an evaluation function, and the search progresses through neighboring voxels toward the voxel including the listener. When the computational resource constraint is detected, the search is terminated prior to reaching the voxel including the listener. In response, the path is completed by connecting the current voxel to the listener using a straight-line segment. The resulting path includes a sequence of voxels determined during the shortest-path search and the straight-line segment extending from the current voxel to the listener.

In some implementations, performing the shortest-path search includes minimizing a cost function including distance multiplied by voxel density. The cost function includes a value associated with traversing between voxels, where the value is computed based on a distance between voxel locations and a density value associated with one or more voxels along a candidate path. The distance may include a Euclidean distance, a Manhattan distance, or another spatial distance metric between voxel centers. The density value includes a value computed for each voxel based on intersection with geometry in the 3D virtual environment. For a given candidate path, the cost function may be computed by aggregating products of distance and density for successive voxel transitions. The shortest-path search evaluates candidate paths and selects a path that minimizes the cost function, such that paths that traverse regions associated with higher density values contribute a larger cost than paths that traverse regions associated with lower density values.

In some implementations, performing the shortest-path search is executed on a computer program thread that is decoupled from a rendering frame loop that executes rendering of the audio. A program thread includes an execution context managed by a processor that performs operations independently of other execution contexts. The rendering frame loop includes a sequence of operations that are executed periodically to update visual and audio output for the 3D virtual environment. Decoupling the shortest-path search from the rendering frame loop includes executing the shortest-path search on a separate thread such that execution of the shortest-path search does not block or delay execution of the rendering frame loop. The separate thread may update path data asynchronously, and the rendering frame loop may access the updated path data to apply adjustments to audio during rendering at the listener.

In some implementations, constructing the voxel grid is performed incrementally during performing of the shortest-path search as voxels are visited during the shortest-path search. Incremental construction includes generating voxel data for regions of the 3D virtual environment on demand as the search progresses, rather than generating all voxels in advance. During the shortest-path search, a current voxel is selected and neighboring voxels are identified for further traversal. As each voxel is visited, a corresponding voxel entry is created or updated in the voxel grid, and a density value is computed for the voxel based on intersection with geometry obtained from the physics data structure. Voxels that are not visited during the search are not constructed or evaluated. The voxel grid is expanded dynamically outward from the voxel including the sound emitter as the shortest-path search proceeds toward the voxel including the listener.

In some implementations, computing the respective density value for each voxel includes querying collision or material data from the physics data structure, and assigning the density value based on collision or material properties of geometry intersecting the voxel. Querying the physics data structure includes performing a spatial query using the voxel bounds to identify geometry that intersects the voxel, and retrieving associated attributes such as collision flags, surface types, or material identifiers. Collision properties include whether geometry blocks traversal through the voxel, and material properties include characteristics associated with surfaces or objects present in the voxel. The density value is computed using the retrieved properties, such that different types of geometry produce different density values. For example, a voxel that intersects solid structural geometry may be assigned a higher density value than a voxel intersecting empty space, and a voxel intersecting geometry associated with a particular material may be assigned a density value corresponding to that material.

In some implementations, assigning the density value based on collision or material properties includes mapping different types of geometry to different density values based on interaction with sound within the 3D virtual environment. For example, a voxel that intersects with solid structural geometry, such as stone, concrete, or brick, may be assigned a higher density value than a voxel that intersects with less obstructive geometry. A voxel that intersects with partially permeable or flexible materials, such as fabric, vegetation, or other non-rigid structures, may be assigned a lower density value relative to the solid structural geometry. A voxel that does not intersect with any geometry is assigned a density value corresponding to free space. In some implementations, a voxel that intersects with sound-absorbing material is assigned a density value based on absorption characteristics associated with the material. The density value is thus determined based on one or more of solidity, permeability, or material characteristics of geometry intersecting the voxel.

In some implementations, incrementally constructing the voxel grid includes computing axis-aligned neighboring voxels of a current voxel, computing a respective density value for each of the axis-aligned neighboring voxels based on intersection with geometry in the 3D virtual environment, and extending the path to include one of the axis-aligned neighboring voxels based on the density values of the axis-aligned neighboring voxels. Axis-aligned neighboring voxels include voxels that share a face with the current voxel along principal axes of the coordinate system, such as left, right, above, below, forward, and backward directions. For each neighboring voxel, spatial bounds are determined and a query is performed against the physics data structure to identify intersecting geometry and compute a corresponding density value. The shortest-path search evaluates the neighboring voxels using their density values and selects one of the neighboring voxels to extend the path based on an evaluation of traversal cost.

In some implementations, the shortest-path search includes a weighted A* search that evaluates candidate voxels using an evaluation function comprising a path cost from the sound emitter to a current voxel and a heuristic estimate from the current voxel to the listener, wherein the heuristic estimate is multiplied by a weight greater than one. The path cost includes a cumulative value associated with traversal from the voxel including the sound emitter to the current voxel, based on distance and density values of voxels along the path. The heuristic estimate includes an estimate of remaining distance between the current voxel and the voxel including the listener, and may be computed using a distance metric such as Euclidean distance. The evaluation function combines the path cost and the weighted heuristic estimate to determine an ordering of candidate voxels for expansion during the search. The weight applied to the heuristic estimate increases the influence of the estimate in the evaluation function relative to the path cost.

In some implementations, the weight is adjusted dynamically based on a time threshold, where adjusting the weight modifies a relative contribution of a path cost from the sound emitter to a current voxel and a heuristic estimate from the current voxel to the listener during the weighted A* search. The time threshold includes a value associated with elapsed execution time of the weighted A* search or a time budget allocated for the search. During execution of the search, the elapsed time is monitored, and the weight applied to the heuristic estimate is updated based on comparison with the time threshold. Increasing the weight increases the influence of the heuristic estimate relative to the path cost in the evaluation function, while decreasing the weight increases the influence of the path cost relative to the heuristic estimate. The updated weight is applied in subsequent evaluations of candidate voxels during continuation of the weighted A* search.

In some implementations, the operations are performed individually for each sound emitter such that performance of the operations for a first sound emitter that is closer to the listener than a second sound emitter is prioritized over performance of the operations for the second sound emitter. In some implementations, the operations may be performed in parallel for multiple sound emitters. The operations include one or more of constructing the voxel grid, computing density values, performing the shortest-path search, determining the arrival direction, and adjusting one or more audio rendering parameters. A distance between each sound emitter and the listener is determined, and the sound emitters are ordered based on the distance. A priority value is assigned to each sound emitter based on the distance, such that a sound emitter associated with a smaller distance to the listener is processed before a sound emitter associated with a larger distance. The prioritized processing is applied when allocating processing time or selecting a sound emitter for execution of path-related operations.

In some implementations, the operations are performed individually for each sound emitter, and a frequency of path updates for a first sound emitter that is closer to the listener than a second sound emitter is higher than a frequency of path updates for the second sound emitter. A path update includes recomputation or refresh of a path between a voxel including a sound emitter and a voxel including the listener, including associated arrival direction and cumulative density values. Distances between respective sound emitters and the listener are determined, and update scheduling is assigned based on the distances. A first sound emitter associated with a smaller distance to the listener is assigned a shorter update interval than a second sound emitter associated with a larger distance to the listener. As a result, the path for the first sound emitter is recomputed more frequently than the path for the second sound emitter during continued execution in the 3D virtual environment.

In some implementations, a beam search is performed during the shortest-path search, where the beam search utilizes a min-max heap to prune voxels based on a computational cost threshold. The beam search includes maintaining a bounded set of candidate voxels during execution of the shortest-path search rather than retaining all candidate voxels generated during expansion. The min-max heap includes a data structure that supports retrieval of candidate voxels associated with lower computational cost values and candidate voxels associated with higher computational cost values. As candidate voxels are generated, a computational cost is determined for each candidate voxel based on an evaluation function used in the shortest-path search. Candidate voxels associated with computational cost values that exceed the computational cost threshold are removed from the min-max heap, such that subsequent traversal operations are performed using a reduced set of candidate voxels.

In some implementations, construction of the voxel grid is performed element-by-element during execution of the shortest-path search as the search progresses from the voxel including the sound emitter toward the voxel including the listener. The shortest-path search begins at a first voxel that includes the sound emitter, and a current voxel is selected for processing based on an evaluation function. For the current voxel, a set of neighboring voxels is generated, and for each neighboring voxel, a corresponding voxel element is constructed in the voxel grid and a density value is computed based on intersection with geometry in the 3D virtual environment. Each constructed voxel is added to a set of candidate voxels for further traversal. As the shortest-path search proceeds, additional voxels are constructed when reached through traversal from previously constructed voxels, such that the voxel grid expands outward from the sound emitter along paths explored by the search. The construction of voxel elements continues until the voxel including the listener is reached or a termination condition is detected.

In some implementations, a previously determined path for the sound emitter is cached, and the cached previously determined path is utilized to render audio when a current weighted shortest-path search is deprioritized or reaches a frame time budget constraint (latency limit to render to the audio which may include one or more audio frames). The cached path includes a sequence of voxels and associated data including cumulative density values and arrival direction information determined during a prior execution of the shortest-path search. During execution of a current shortest-path search, a determination may be made that the search is deprioritized relative to other sound emitters or that a frame time budget constraint associated with a rendering frame loop is reached. In response, the cached path is accessed and used to determine audio rendering parameters, including directional panning and amplitude attenuation, instead of a path that would otherwise be determined by completing the current shortest-path search. The cached path may be updated during subsequent executions of the shortest-path search when sufficient computational resources are available. Block 206 is followed by block 208.

At block 208, an arrival direction is determined for audio emitted by the sound emitter based on a final segment of the path. Audio includes a signal associated with sound produced by a sound emitter and rendered at a listener within the 3D virtual environment. The path includes a sequence of voxels connecting a first voxel that includes the sound emitter to a second voxel that includes the listener. The final segment includes a portion of the path corresponding to a last connection between voxels that terminates at or near the voxel including the listener.

An arrival direction includes a directional vector that represents a direction from which the audio is perceived to reach the listener. The arrival direction is determined relative to a coordinate system associated with the 3D virtual environment. For example, the arrival direction may include a vector defined in Cartesian coordinates that extends from a point along the final segment toward the listener. In some implementations, the arrival direction is represented using a normalized vector that indicates direction without magnitude.

In some implementations, the final segment includes a connection between a penultimate voxel and the voxel that includes the listener. The arrival direction may be computed using positions associated with the penultimate voxel and the listener. For example, the arrival direction may be computed as a vector from a centroid of the penultimate voxel to a position of the listener. In some implementations, if the path is completed using a straight-line segment due to a computational resource constraint, the final segment includes the straight-line connection from a current voxel to the listener.

In some implementations, determining the arrival direction includes calculating angular components associated with the directional vector. The angular components may include azimuth and elevation angles relative to an orientation of the listener. For example, the azimuth angle may indicate a horizontal direction of arrival, and the elevation angle may indicate a vertical direction of arrival. The angular components may be derived from the directional vector and used in subsequent audio rendering operations.

In some implementations, the arrival direction is computed based on a smoothed representation of the final segment. The smoothed representation may include averaging positions of multiple voxels near the end of the path or applying interpolation between voxel centers to reduce discontinuities in the direction. The arrival direction may be updated over time as the path changes, e.g., due to movement of the sound emitter, the listener, or geometry within the 3D virtual environment.

In some implementations, the arrival direction is associated with a coordinate frame of the listener. The coordinate frame includes an orientation of the listener within the 3D virtual environment, such as a forward direction, a right direction, and an up direction. The directional vector may be transformed into the coordinate frame of the listener to determine relative direction of the audio. Block 208 is followed by block 210.

At block 210, at least one of directional panning or amplitude attenuation of the audio emitted by the sound emitter is adjusted based on the arrival direction and cumulative density values along the path. Directional panning includes an operation that distributes an audio signal across one or more output channels based on a spatial direction associated with the audio. Amplitude attenuation includes an operation that modifies a magnitude of the audio signal to represent reduction in perceived loudness. Cumulative density values include an aggregation of density values associated with voxels along the path between the sound emitter and the listener.

In some implementations, cumulative density values are computed by combining density values of voxels that form the path. The combination may include summation of density values, weighted summation based on distance between voxels, or other aggregation techniques. For example, a path that traverses voxels associated with solid geometry may produce a higher cumulative density value than a path that traverses voxels associated with empty space. The cumulative density value is associated with the path and is used to determine how the audio signal is modified prior to rendering.

In some implementations, amplitude attenuation is determined based on the cumulative density value. The amplitude attenuation may include applying a scaling factor to the audio signal, where the scaling factor is derived from the cumulative density value. For example, a higher cumulative density value may correspond to a lower amplitude of the audio signal at the listener, while a lower cumulative density value may correspond to a higher amplitude. The scaling factor may be computed using a mapping function, such as, e.g., a linear function, exponential function, or lookup table that maps cumulative density values to attenuation levels.

In some implementations, directional panning is determined based on the arrival direction computed at block 208. The arrival direction is used to compute relative contributions of the audio signal to different output channels. For example, in a stereo configuration, the arrival direction may be used to determine a proportion of the audio signal assigned to a left channel and a right channel of the stereo configuration . In a multi-channel configuration (e.g., spatial audio, surround sound, etc. that include multiple channels of audio playback), the arrival direction may be used to distribute the audio signal across multiple speakers or channels using spatial audio techniques.

In some implementations, the directional panning is performed using vector-base amplitude panning. Vector-base amplitude panning includes computing gain values for output channels based on a directional vector associated with the arrival direction. The gain values determine the distribution of the audio signal across the output channels. For example, a sound arriving from a direction to the left of the listener may be assigned a higher gain in a left channel than in a right channel. The gain values may be computed based on angular relationships between the arrival direction and speaker positions.

In some implementations, adjustment of directional panning and amplitude attenuation is performed in combination. The audio signal may first be attenuated based on the cumulative density value and distributed across output channels based on the arrival direction. Alternatively, the audio signal may be distributed across output channels and attenuated for each channel based on the cumulative density value. The adjusted audio signal is provided to an audio rendering component (playback component) that outputs the audio at the listener.

In some implementations, cumulative density values along the path are used to adjust one or more audio rendering parameters including the directional panning or the amplitude attenuation, wherein higher cumulative density values correspond to higher attenuation of audio rendered at the listener. The cumulative density values include an aggregate of density values associated with voxels that form the path between the sound emitter and the listener. The aggregate may include a summation or another combination of density values along the path. The cumulative density values are used to determine an attenuation level applied to the audio signal, such that an increase in cumulative density values corresponds to an increase in attenuation applied to the audio signal at the listener. The adjustment of directional panning may be performed in conjunction with the attenuation, where the arrival direction determines distribution of the audio signal across output channels and the cumulative density values determine a magnitude of the audio signal applied to the output channels.

In some implementations, the one or more audio rendering parameters include an amplitude attenuation factor applied to the sound emitter at the listener. The amplitude attenuation factor includes a scalar value that is applied to an audio signal associated with the sound emitter to modify a magnitude of the audio signal prior to rendering at the listener. The amplitude attenuation factor may be determined based on cumulative density values along the path and may be applied as a gain value to the audio signal. For example, the amplitude attenuation factor may include a value between zero and one, where a value closer to zero corresponds to a greater reduction in amplitude and a value closer to one corresponds to a smaller reduction. The amplitude attenuation factor is applied to the audio signal before or during distribution of the audio signal across output channels.

In some implementations, the directional panning is performed using vector-base amplitude panning based on the arrival direction. Vector-base amplitude panning includes computing gain values for a plurality of output channels based on a directional vector corresponding to the arrival direction of the audio. The arrival direction is expressed in a coordinate system associated with the listener, and each output channel is associated with a predefined direction within the coordinate system. Gain values for the output channels are computed based on angular relationships between the arrival direction and the directions associated with the output channels. The gain values are applied to the audio signal to distribute the audio signal across the output channels, such that the perceived direction of the audio at the listener corresponds to the arrival direction.

In some implementations, it is determined whether a direct line of sight exists between the sound emitter and the listener, where the adjusting is performed in response to absence of the direct line of sight. A direct line of sight includes an unobstructed path between a position of the sound emitter and a position of the listener within the 3D virtual environment. Determining whether the direct line of sight exists includes performing a visibility query using the physics data structure, such as a raycast from the sound emitter to the listener, to detect whether geometry intersects a line between the sound emitter and the listener. If geometry intersects the line, the direct line of sight is absent, and adjustment of directional panning or amplitude attenuation based on the arrival direction and cumulative density values is applied. If no geometry intersects the line, the direct line of sight is present, and the audio may be rendered without applying one or more adjustments associated with obstruction between the sound emitter and the listener. Block 210 is followed by block 212.

At block 212, after the adjusting, the audio is rendered at the listener. Rendering the audio includes generating one or more output audio signals based on adjusted audio parameters and providing the output audio signals to an audio output device. The listener includes a position within the 3D virtual environment at which the audio is perceived, and may be associated with a camera, an avatar, or another representation of a user. In some implementations, the audio is played back to a user that is associated with an avatar that is at or near the position of listener via audio equipment that the user is using, such as headphones, speakers, etc.). The rendered audio corresponds to the audio emitted by the sound emitter after application of directional panning and amplitude attenuation.

In some implementations, rendering the audio includes converting a digital audio signal into one or more channel-specific output signals. The conversion may include applying gain values, channel mixing, and formatting operations based on the adjusted audio parameters. For example, the audio signal may be processed to generate left and right channel outputs in a stereo configuration, or multiple channel outputs in a surround sound configuration. The channel-specific output signals are provided to an audio playback system.

In some implementations, rendering the audio includes synchronizing playback of the adjusted audio signal with a state of the 3D virtual environment. The state of the 3D virtual environment may include positions and orientations of the sound emitter and the listener, as well as changes in geometry or other environmental conditions. Synchronization may include updating the rendered audio in response to changes in the path, arrival direction, or cumulative density values as the values are recomputed over time.

In some implementations, rendering the audio includes interfacing with an audio engine that processes audio signals for playback. The audio engine may include components for mixing multiple audio signals, applying additional audio effects, and managing audio buffers. The adjusted audio signal associated with the sound emitter is combined with other audio signals in the environment, such as signals from additional sound emitters, background audio, or user interface sounds, prior to output.

In some implementations, rendering the audio includes providing output signals to one or more audio output devices. The audio output devices may include speakers, headphones, or other transducers capable of producing sound. The output signals are converted from digital representations to analog signals by a digital-to-analog converter and transmitted to the audio output devices. The listener perceives the rendered audio based on the adjusted parameters that were applied prior to rendering.

In some implementations, rendering the audio includes updating audio output continuously as the listener or sound emitter moves within the 3D virtual environment. Changes in position or orientation may result in recomputation of the path, arrival direction, or cumulative density values, which in turn affect the adjusted audio parameters. The rendering applies updated parameters to the audio signal and outputs the updated audio at the listener.

In some implementations, one or more of blocks 202-212 may be performed by one or more server devices, and one or more of blocks 202-212 may be performed by one or more client devices. In some implementations, all of method 200 may be performed by a server device, or by a client device. In some implementations, one or more of blocks 202-212 may be performed in parallel. Various blocks may be omitted, combined, modified, supplemented with additional blocks, performed in a different order than depicted in FIG. 2, etc.

In various implementations, the techniques described herein may include combinations of one or more features recited in the claims. For example, in some implementations, a computer-implemented method includes constructing a voxel grid centered at a sound emitter in a 3D virtual environment, wherein the voxel grid includes a plurality of voxels and each voxel in the voxel grid corresponds to a respective volume in the 3D virtual environment; computing a respective density value for each voxel based on intersection with geometry in the 3D virtual environment using a physics data structure that represents the geometry; performing a shortest-path search to determine a path from a first voxel that includes the sound emitter to a second voxel that includes a listener in the 3D virtual environment; determining an arrival direction for audio emitted by the sound emitter based on a final segment of the path; adjusting at least one of directional panning or amplitude attenuation of the audio emitted by the sound emitter based on the arrival direction and cumulative density values along the path; and after the adjusting, rendering the audio at the listener. In some implementations, the method further includes determining whether a direct line of sight exists between the sound emitter and the listener, wherein the adjusting is performed in response to absence of the direct line of sight, and/or determining the path includes detecting that a computational resource constraint is met during the performing the shortest-path search and, in response to detecting that the computational resource constraint is met, completing the path with a straight-line segment to the listener.

In some implementations, a computer-implemented method includes constructing a voxel grid centered at a sound emitter in a 3D virtual environment, wherein the voxel grid includes a plurality of voxels and each voxel in the voxel grid corresponds to a respective volume in the 3D virtual environment; computing a respective density value for each voxel based on intersection with geometry in the 3D virtual environment using a physics data structure that represents the geometry; performing a shortest-path search to determine a path from a first voxel that includes the sound emitter to a second voxel that includes a listener in the 3D virtual environment; determining an arrival direction for audio emitted by the sound emitter based on a final segment of the path; adjusting at least one of directional panning or amplitude attenuation of the audio emitted by the sound emitter based on the arrival direction and cumulative density values along the path; and after the adjusting, rendering the audio at the listener, wherein performing the shortest-path search includes minimizing a cost function comprising distance multiplied by voxel density, and/or wherein performing the shortest-path search is executed on a program thread that is decoupled from a rendering frame loop that executes the rendering of the audio.

In some implementations, a computer-implemented method includes constructing a voxel grid centered at a sound emitter in a 3D virtual environment, wherein the voxel grid includes a plurality of voxels and each voxel in the voxel grid corresponds to a respective volume in the 3D virtual environment; computing a respective density value for each voxel based on intersection with geometry in the 3D virtual environment using a physics data structure that represents the geometry; performing a shortest-path search to determine a path from a first voxel that includes the sound emitter to a second voxel that includes a listener in the 3D virtual environment; determining an arrival direction for audio emitted by the sound emitter based on a final segment of the path; adjusting at least one of directional panning or amplitude attenuation of the audio emitted by the sound emitter based on the arrival direction and cumulative density values along the path; and after the adjusting, rendering the audio at the listener, wherein performing the shortest-path search is executed on a program thread that is decoupled from a rendering frame loop that executes the rendering of the audio, and wherein constructing the voxel grid is performed incrementally during the performing of the shortest-path search as voxels are visited during the shortest-path search, optionally including computing the respective density value for each voxel by querying collision or material data from the physics data structure and assigning the density value based on collision or material properties of geometry intersecting the voxel.

In some implementations, a computer-implemented method includes constructing a voxel grid centered at a sound emitter in a 3D virtual environment, wherein the voxel grid includes a plurality of voxels and each voxel in the voxel grid corresponds to a respective volume in the 3D virtual environment; computing a respective density value for each voxel based on intersection with geometry in the 3D virtual environment using a physics data structure that represents the geometry; performing a shortest-path search to determine a path from a first voxel that includes the sound emitter to a second voxel that includes a listener in the 3D virtual environment; determining an arrival direction for audio emitted by the sound emitter based on a final segment of the path; adjusting at least one of directional panning or amplitude attenuation of the audio emitted by the sound emitter based on the arrival direction and cumulative density values along the path; and after the adjusting, rendering the audio at the listener, wherein constructing the voxel grid is performed incrementally during the performing of the shortest-path search as voxels are visited during the shortest-path search, and wherein incrementally constructing the voxel grid includes computing axis-aligned neighboring voxels of a current voxel, computing a respective density value for each of the axis-aligned neighboring voxels based on intersection with geometry in the 3D virtual environment, and extending the path to include one of the axis-aligned neighboring voxels based on the density values of the axis-aligned neighboring voxels.

In some implementations, a computer-implemented method includes constructing a voxel grid centered at a sound emitter in a 3D virtual environment, wherein the voxel grid includes a plurality of voxels and each voxel in the voxel grid corresponds to a respective volume in the 3D virtual environment; computing a respective density value for each voxel based on intersection with geometry in the 3D virtual environment using a physics data structure that represents the geometry; performing a shortest-path search to determine a path from a first voxel that includes the sound emitter to a second voxel that includes a listener in the 3D virtual environment; determining an arrival direction for audio emitted by the sound emitter based on a final segment of the path; adjusting at least one of directional panning or amplitude attenuation of the audio emitted by the sound emitter based on the arrival direction and cumulative density values along the path; and after the adjusting, rendering the audio at the listener, wherein the shortest-path search includes a weighted A* search that evaluates candidate voxels using an evaluation function comprising a path cost from the sound emitter to a current voxel and a heuristic estimate from the current voxel to the listener, wherein the heuristic estimate is multiplied by a weight greater than one, optionally including adjusting the weight dynamically based on a time threshold, wherein adjusting the weight modifies a relative contribution of a path cost from the sound emitter to a current voxel and a heuristic estimate from the current voxel to the listener during the weighted A* search.

In some implementations, a computer-implemented method includes constructing a voxel grid centered at a sound emitter in a 3D virtual environment, wherein the voxel grid includes a plurality of voxels and each voxel in the voxel grid corresponds to a respective volume in the 3D virtual environment; computing a respective density value for each voxel based on intersection with geometry in the 3D virtual environment using a physics data structure that represents the geometry; performing a shortest-path search to determine a path from a first voxel that includes the sound emitter to a second voxel that includes a listener in the 3D virtual environment; determining an arrival direction for audio emitted by the sound emitter based on a final segment of the path; adjusting at least one of directional panning or amplitude attenuation of the audio emitted by the sound emitter based on the arrival direction and cumulative density values along the path; and after the adjusting, rendering the audio at the listener, wherein cumulative density values along the path are used to adjust one or more audio rendering parameters including the directional panning or the amplitude attenuation, wherein higher cumulative density values correspond to higher attenuation of audio rendered at the listener, optionally including applying an amplitude attenuation factor to the sound emitter at the listener.

In some implementations, various combinations of the foregoing features may be used together. For example, implementations may include determining whether a direct line of sight exists between the sound emitter and the listener together with minimizing a cost function comprising distance multiplied by voxel density, or may include executing the shortest-path search on a program thread decoupled from a rendering frame loop together with incrementally constructing the voxel grid and evaluating axis-aligned neighboring voxels, or may include performing a weighted A* search together with dynamically adjusting the weight based on a time threshold and using cumulative density values to adjust directional panning or amplitude attenuation. In some implementations, sub-combinations of these features may be applied depending on runtime conditions, computational constraints, or characteristics of the 3D virtual environment.

### Rendered scene without audio occlusion and diffraction

FIG. 3A illustrates a rendered scene from a virtual environment in which audio occlusion and diffraction have not been enabled. The viewpoint is positioned outside a structure that is constructed from solid virtual materials, including stone-textured walls and a wooden roof. Despite the presence of the visual obstructions, audio originating from within or behind the structure is rendered as fully audible to the listener, without any reduction in amplitude or any change in perceived direction.

In the configuration, the audio engine does not account for intervening geometry and enables all emitter signals to reach the listener as if the environment were acoustically transparent. For example, sounds such as a crackling fire, a ringing anvil, or a mechanical chute are presented at full volume and with direct, unmodified spatial cues, regardless of the listener’s position relative to the obstructing building. This results in perceptually unrealistic behavior because there is no muffling, shadowing, or spatial redirection of the sound when solid geometry exists between the source and the listener.

The audio perception depicted in FIG. 3A corresponds to a baseline configuration in which sound emitters are treated as always audible unless explicitly filtered. In the scene, the camera position, which further serves as the listener position, is located behind the obstructing structure. Sounds from emitters located inside or beyond the structure are rendered with full clarity and are not affected by any intervening materials that would normally reduce intensity or change arrival direction.

FIG. 3B illustrates a rendered scene from a virtual environment in which audio occlusion and diffraction have not been enabled. The viewpoint is positioned within a stone-walled structure including a furnace and an anvil, each associated with an active audio emitter. The furnace emits a fire crackling sound, and the anvil emits the sound of metal being struck. The structural layout includes stone walls, archways, and columns, which affect sound behavior in a physically realistic setting.

In the configuration, the audio engine does not take into account the presence of geometry when determining what the listener hears. As a result, both the fire and anvil sounds are rendered at full volume and with direct directional cues, regardless of whether the listener is positioned within a line of sight to the emitters or is separated by intervening surfaces. The environment is acoustically transparent, and no adjustments are made for muffling, redirection, or energy loss due to obstacles.

Although the scene includes visual boundaries and architectural features that would cause obstruction or diffraction in real-world audio, the features are not used in the configuration to influence the rendered sound. The listener hears both audio sources as if the space were open and unobstructed, which results in perceptual inaccuracies such as an absence of directional filtering or realistic attenuation.

### Rendered scene with audio occlusion and diffraction enabled

FIG. 3C illustrates a rendered scene from a virtual environment in which both audio occlusion and diffraction have been enabled. The viewpoint is positioned just outside a partially enclosed stone structure that includes wooden beams and an overhanging roof. Inside the structure, audio emitters such as a furnace and anvil are active, producing sounds of fire crackling and metal striking, respectively. The wall in the foreground partially blocks the line of sight between the listener and the emitters, creating conditions for evaluating both occlusion and diffraction handling.

In the configuration, the audio engine evaluates direct visibility between the emitter and listener and applies occlusion filtering when geometry obstructs the direct path. For example, when the listener moves behind the stone wall, the sound from the emitters is perceptibly muffled due to simulated energy loss from obstruction. The behavior reflects a basic occlusion model that accounts for physical barriers attenuating sound energy.

In addition to occlusion, the audio engine simulates audio diffraction by evaluating alternate paths that sound may take around obstacles. When a sound source is located just out of view—such as around the corner formed by the wall in the foreground—the sound remains partially audible and appears to arrive from an indirect direction. This is accomplished by computing a path through a voxel grid and selecting a route with decreased distance and density. The resulting sound output is not simply silenced when the emitter moves out of line of sight, but instead bends around the corner, consistent with how real-world sound propagation behaves.

### Rendered scene with visual debugging for audio pathfinding enabled

FIG. 3D illustrates a rendered scene from a virtual environment in which visual debugging for audio pathfinding has been enabled. Graphical overlays are displayed in the rendered scene to represent a computed sound path between a sound emitter and a listener. The overlays include a sequence of connected voxel segments that trace a route through the environment from the sound emitter to the listener. The sound emitter is located inside a stone structure in the foreground, and the listener is positioned outside the structure such that direct line of sight between the sound emitter and the listener is obstructed by portions of the structure. The scene includes additional buildings and terrain elements that define the geometry through which the path is computed.

Both audio occlusion and diffraction are active, and the audio engine computes a voxel-based path from the emitter to the listener that accounts for geometry. The overlay displays the path as a sequence of voxel segments shown in alternating bands (illustrated with different shades of gray), which indicate the progression of the evaluated route through the environment. The path curves around the stone structure enclosing the sound emitter, avoiding direct intersection with the geometry of the structure, and reflects a route that decreases cumulative distance and density.

The visualized path demonstrates the operation of the audio pathfinding techniques, which search for valid routes around obstacles by expanding axis-aligned neighbors in a three-dimensional voxel grid. Each segment along the path corresponds to a traversed voxel, and the geometry-aware search enables the resulting route to accurately model how sound would bend or diffuse around barriers in a real-world setting. The visual information aids developers in verifying path correctness, debugging audio behavior, and tuning parameters for occlusion and diffraction.

FIG. 3E illustrates a view from within an interior space of a virtual environment in which audio pathfinding visualization has been enabled. The camera viewpoint is located inside a stone-walled room that includes a furnace structure and other objects, including a sound emitter located within the room. A sequence of voxel segments is displayed as graphical overlays in the rendered scene, where the voxel segments trace a computed sound path extending from the sound emitter toward a listener located outside the room. The voxel segments follow interior geometry of the room and extend toward an opening in the furnace structure and surrounding passage through which the path progresses toward the exterior.

The scene demonstrates an interior portion of a sound path determined using voxel-based search techniques. The path progresses through the room while avoiding traversal through voxels associated with higher density values corresponding to the stone walls and furnace structure, and extends toward the listener via a route that reflects diffraction-aware behavior. The displayed voxel segments illustrate how the path navigates around interior geometry and exits the enclosed space toward the listener.

The scene demonstrates an interior portion of a sound path determined using voxel-based search techniques. The path progresses through the room while avoiding traversal through voxels associated with higher density values corresponding to the stone walls and furnace structure, and extends toward the listener via a route that reflects diffraction-aware behavior. The displayed voxel segments illustrate how the path navigates around interior geometry and exits the enclosed space toward the listener.

FIG. 3F illustrates a scene from a virtual environment showing a combination of audio pathfinding visualization and directional arrival indicators. The camera viewpoint is located inside a stone structure observing an interior region in which sound emitters are present and audible to a listener located outside the structure such that portions of the structure obstruct direct line of sight. The image includes graphical overlays that depict both a computed audio path represented by a sequence of voxel segments and arrival direction indicators represented by linear directional guides. The voxel segments trace a path through the environment, while the linear directional guides indicate a direction from which audio from each sound emitter is perceived to arrive at the listener.

A series of volumetric segments trace the computed path from the emitter to the listener. The path represents the result of voxel-based search techniques that evaluate travel cost based on distance and material density. The path follows a curved route around the obstructing geometry, consistent with real-world diffraction behavior. It avoids intersecting solid surfaces and instead proceeds through free space and around corners, enabling sound to reach the listener despite the absence of a direct line of sight.

In addition to the computed path, thin linear indicators are shown extending from the listener position. The lines represent the calculated angle of arrival for each sound, which is determined from the final segment of the path. The audio engine uses the arrival direction to apply spatial audio effects such as directional panning, enabling the listener to perceive each emitter as originating from a plausible direction, even when the emitter’s physical location is not directly visible.

FIG. 3G illustrates a rendered scene from a virtual environment in which multiple audio emitters are active and audio pathfinding visualizations are enabled. The viewpoint is positioned in an outdoor area between multiple structures, including a house-like structure on the left side of the scene and a stone or wood structure on the right side of the scene. A listener is positioned near a bottom-center region of the frame, indicated by a listener icon. Multiple sound emitters are located within or near the structures on the left and right sides of the scene, and volumetric voxel path segments are shown extending from these emitter locations toward the listener. Portions of the structures obstruct direct line of sight between the emitters and the listener, resulting in paths that bend around the structures.

FIG. 3G further demonstrates a behavior in which pathfinding computation is managed dynamically based on emitter proximity to the listener. Emitters located closer to the listener, including emitters associated with structures nearer to the bottom-center region of the frame, are assigned higher priority for path computation and are updated more frequently. Emitters located farther from the listener, including emitters associated with structures deeper in the scene, are assigned lower priority and may be updated less frequently. The displayed voxel paths illustrate this prioritization, where paths associated with closer emitters appear more stable and continuously updated, while paths associated with farther emitters may exhibit reduced update frequency. For emitters located farther from the listener, pathfinding updates are deprioritized. The emitters are allocated less frame time, and their paths may remain slightly out of date or be resolved more slowly. The approach reflects an optimization strategy that assumes lower perceptual sensitivity to inaccuracies or latency in distant sounds. By adjusting the update frequency based on distance, the approach maintains real-time responsiveness while controlling overall computational cost.

FIG. 3H illustrates a rendered scene from a virtual environment with visual audio pathfinding overlays enabled, shown as alternating bands with varying shades of gray. The camera viewpoint captures a top-down view of a village-like area that includes multiple buildings, pathways, and terrain features. A listener is positioned within the scene and is indicated by a listener icon located slightly left of center in the frame. Volumetric voxel segments representing a computed sound path extend from one or more sound emitters within surrounding structures toward the current position of the listener. The displayed path corresponds to a path computed for the current listener position and reflects traversal around geometry in the environment.

The scene demonstrates dynamic path resolution in real time, where the listener's position affects which paths are most actively updated. As the listener is moved through the environment, emitters that are closer to the new listener position receive increased computational priority. Their corresponding paths become more stable and fully resolved, as they are refreshed with greater frequency. This enables accurate arrival direction and occlusion modeling for sources that are most perceptually relevant.

In contrast, emitters located farther from the listener are deprioritized, and their paths may begin to flicker or update less frequently. The behavior reflects a frame time budgeting strategy in which closer emitters are considered more critical for spatial audio fidelity, while distant emitters are permitted to use cached or delayed path data. The visual appearance of flickering paths indicates that less compute time is allocated to those emitters in the current frame.

### Computing device

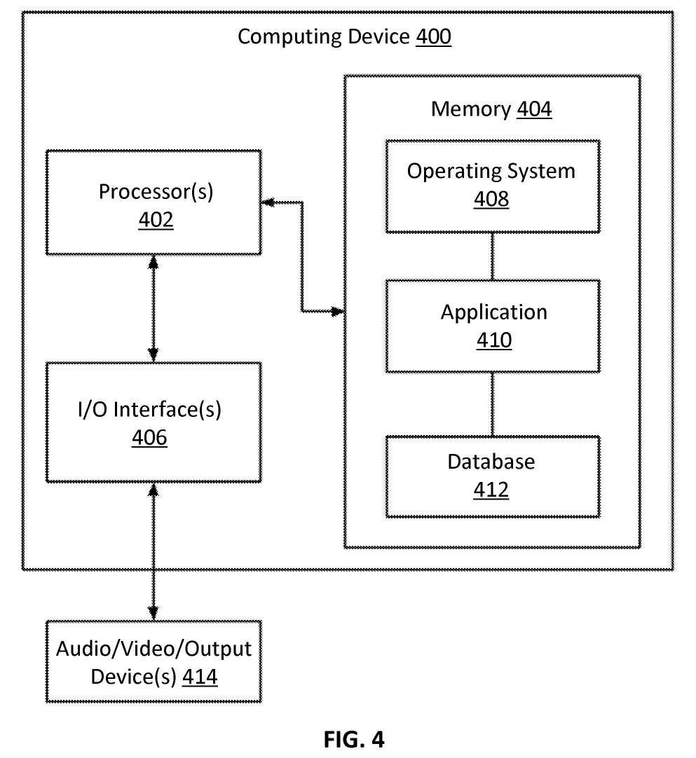

FIG. 4 is a block diagram of an example computing device 400 which may be used to implement one or more techniques described herein. In one example, device 400 may be used to implement a computer device (e.g., 102 and/or 110 of FIG. 1), and perform appropriate method implementations described herein. Computing device 400 can be any suitable computer system, server, or other electronic or hardware device. For example, the computing device 400 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 400 includes a processor 402, a memory 404, input/output (I/O) interface 406, and audio/video input/output devices 414.

Processor 402 can be one or more processors and/or processing circuits to execute program code and control basic operations of the device 400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 404 is provided in device 400 for access by the processor 402, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 402 and/or integrated therewith. Memory 404 can store software operating on the server device 400 by the processor 402, including an operating system 407, one or more applications 410, and a database 412 that may store data used by the components of device 400.

Database 412 may store one or more mechanisms, including voxel grid configuration data, shortest-path search parameters, and audio rendering data for determining paths between sound emitters and listeners in a 3D virtual environment. In some implementations, database 412 may store information associated with sound emitters and listeners, such as emitter identifiers, listener positions, voxel identifiers, and physics data structure information used to compute density values for voxels based on intersection with geometry in the 3D virtual environment. The stored data can include density values for voxels, path data identifying sequences of voxels between a sound emitter and a listener, cumulative density values along a path, arrival direction data, and audio rendering parameters including the directional panning values and the amplitude attenuation factors. For example, in a multiplayer gaming environment, database 412 may store metadata for multiple sound emitters, update schedules for path recomputation, computational resource thresholds, weight values for weighted A* search, or data identifying whether direct line of sight exists between a sound emitter and a listener. In some implementations, database 412 may store other data relevant to shortest-path search operations, such as beam search thresholds, min-max heap data, hierarchical voxel structure data, cached path segments, or path update frequency data for different sound emitters. In some implementations, applications 410 can include instructions that enable processor 402 to execute the described techniques, such as constructing a voxel grid, computing density values using the physics data structure, performing a shortest-path search, determining an arrival direction based on a final segment of a path, and adjusting directional panning or amplitude attenuation based on the arrival direction and cumulative density values as described with respect to FIG. 2.

For example, applications 410 can include a module that implements one or more techniques or services used in the techniques described herein, such as constructing voxel grids centered at sound emitters in a 3D virtual environment, computing density values for voxels based on intersection with geometry represented in a physics data structure, performing shortest-path searches between voxels including sound emitters and voxels including listeners, determining arrival directions based on final segments of paths, and adjusting directional panning or amplitude attenuation based on arrival directions and cumulative density values along the paths. Applications 410 can integrate real-time updates that monitor positions of listeners and sound emitters, geometry changes in the 3D virtual environment, direct line-of-sight conditions, and computational resource constraints associated with shortest-path searches. The applications may employ various mechanisms to manage path computation and audio rendering, including executing shortest-path searches on program threads decoupled from rendering frame loops, incrementally constructing voxel grids as voxels are visited, applying weighted A* search with dynamically adjusted weights, prioritizing processing for sound emitters that are closer to a listener, scheduling path recomputation at different frequencies for different sound emitters, and performing beam search or hierarchical voxel processing. Database 412 and/or other connected storage can store various data used in the described techniques, including emitter metadata, listener position data, voxel identifiers, density values, path data, cumulative density values, arrival direction data, direct line-of-sight data, weighted A* parameters, beam search thresholds, hierarchical voxel structure data, cached path segments, and data indicating whether a path is to be recomputed, completed with a straight-line segment, or reused.

Elements of software in memory 404 can alternatively be stored on any other suitable storage location or computer-readable medium. In addition, memory 404 (and/or other connected storage device(s)) can store instructions and data used in the features described herein. Memory 404 and any other type of storage (magnetic disk, optical disk, magnetic tape, or other tangible media) can be considered "storage" or "storage devices."

I/O interface 406 can provide functions to enable interfacing the server device 400 with other systems and devices. For example, network communication devices, storage devices (e.g., memory and/or data store 120), and input/output devices can communicate via interface 406. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 414 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 4 shows one block for each of processor 402, memory 404, I/O interface 406, and software blocks of operating system 408 and virtual experience application 410. The blocks may represent one or more processors or processing circuitries, operating systems, memories, I/O interfaces, applications, and/or software engines (e.g., game engine, audio engine). In other implementations, device 400 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 400 can be a server device or client device. Example client devices or user devices can be computer devices including some similar components as the device 400, e.g., processor(s) 402, memory 404, and I/O interface 406. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 414, for example, can be connected to (or included in) the device 400 to display images pre- and post-processing as described herein, where such display device can include any suitable display device, e.g., a liquid crystal display (LCD), light-emitting diode (LED), or plasma display screen, cathode ray tube (CRT), television, monitor, touchscreen, 3-D display screen, projector, or other visual display device. Some implementations can provide an audio output device, e.g., voice output or synthesis that speaks text.

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be included in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
constructing a voxel grid centered at a sound emitter in a 3D virtual environment, wherein the voxel grid includes a plurality of voxels and each voxel in the voxel grid corresponds to a respective volume in the 3D virtual environment;
computing a respective density value for each voxel based on intersection with geometry in the 3D virtual environment using a physics data structure that represents the geometry;
performing a shortest-path search to determine a path from a first voxel that includes the sound emitter to a second voxel that includes a listener in the 3D virtual environment;
determining an arrival direction for audio emitted by the sound emitter based on a final segment of the path;
adjusting at least one of directional panning or amplitude attenuation of the audio emitted by the sound emitter based on the arrival direction and cumulative density values along the path; and
after the adjusting, rendering the audio at the listener.

2. The computer-implemented method of claim 1, further comprising determining whether a direct line of sight exists between the sound emitter and the listener, wherein the adjusting is performed in response to absence of the direct line of sight.

3. The computer-implemented method of claim 1, wherein determining the path comprises:
detecting that a computational resource constraint is met during the performing the shortest-path search; and
in response to detecting that the computational resource constraint is met, completing the path with a straight-line segment to the listener.

4. The computer-implemented method of claim 1, wherein performing the shortest-path search comprises minimizing a cost function comprising distance multiplied by voxel density.

5. The computer-implemented method of claim 1, wherein performing the shortest-path search is executed on a program thread that is decoupled from a rendering frame loop that executes the rendering of the audio.

6. The computer-implemented method of claim 5, wherein constructing the voxel grid is performed incrementally during the performing of the shortest-path search as voxels are visited during the shortest-path search.

7. The computer-implemented method of claim 6, wherein computing the respective density value for each voxel includes:
querying collision or material data from the physics data structure; and
assigning the density value based on collision or material properties of geometry intersecting the voxel.

8. The computer-implemented method of claim 6, wherein incrementally constructing the voxel grid comprises:
computing axis-aligned neighboring voxels of a current voxel;
computing a respective density value for each of the axis-aligned neighboring voxels based on intersection with geometry in the 3D virtual environment; and
extending the path to include one of the axis-aligned neighboring voxels based on the density values of the axis-aligned neighboring voxels.

9. The computer-implemented method of claim 1, wherein the shortest-path search comprises a weighted A* search that evaluates candidate voxels using an evaluation function comprising a path cost from the sound emitter to a current voxel and a heuristic estimate from the current voxel to the listener, wherein the heuristic estimate is multiplied by a weight greater than one.

10. The computer-implemented method of claim 9, further comprising:
adjusting the weight dynamically based on a time threshold, wherein adjusting the weight modifies a relative contribution of a path cost from the sound emitter to a current voxel and a heuristic estimate from the current voxel to the listener during the weighted A* search.

11. The computer-implemented method of claim 1, wherein cumulative density values along the path are used to adjust one or more audio rendering parameters including the directional panning or the amplitude attenuation, wherein higher cumulative density values correspond to higher attenuation of audio rendered at the listener.

12. The computer-implemented method of claim 11, wherein the one or more audio rendering parameters comprise an amplitude attenuation factor applied to the sound emitter at the listener.

13. A computing device comprising:
one or more processors; and
memory, coupled to the one or more processors and with instructions stored thereon that, when executed by the one or more processors, cause the one or more processors to perform or control performance of operations comprising:
constructing a voxel grid centered at a sound emitter in a 3D virtual environment, wherein the voxel grid includes a plurality of voxels and each voxel in the voxel grid corresponds to a respective volume in the 3D virtual environment;
computing a respective density value for each voxel based on intersection with geometry in the 3D virtual environment using a physics data structure that represents the geometry;
performing a shortest-path search to determine a path from a first voxel that includes the sound emitter to a second voxel that includes a listener in the 3D virtual environment;
determining an arrival direction for audio emitted by the sound emitter based on a final segment of the path;
adjusting at least one of directional panning or amplitude attenuation of the audio emitted by the sound emitter based on the arrival direction and cumulative density values along the path; and
after the adjusting, rendering the audio at the listener.

14. The computing device of claim 13, wherein the directional panning is performed using vector-base amplitude panning based on the arrival direction.

15. The computing device of claim 13, wherein the operations are performed individually for each sound emitter such that performance of the operations for a first sound emitter that is closer to the listener than a second sound emitter is prioritized over performance of the operations for the second sound emitter.

16. The computing device of claim 13, wherein the operations are performed individually for each sound emitter, and wherein a frequency of path updates for a first sound emitter that is closer to the listener than a second sound emitter is higher than a frequency of path updates for the second sound emitter.

17. The computing device of claim 13, wherein the instructions cause the one or more processors to perform or control performance of a further operation comprising:
performing a beam search during the shortest-path search, wherein the beam search utilizes a min-max heap to prune voxels based on a computational cost threshold.

18. The computing device of claim 13, wherein the voxel grid has a hierarchical structure, wherein constructing the hierarchical structure comprises using a larger voxel size for volumes of the 3D virtual environment that do not include the geometry and a smaller voxel size for volumes of the 3D virtual environment that include the geometry.

19. The computing device of claim 13, wherein the instructions cause the one or more processors to perform or control performance of a further operation comprising:
determining whether a direct line of sight exists between the sound emitter and the listener, wherein the adjusting is performed in response to absence of the direct line of sight.

20. A non-transitory computer-readable medium with instructions stored thereon that, when executed by a processor, cause the processor to perform or control performance of operations comprising:
constructing a voxel grid centered at a sound emitter in a 3D virtual environment, wherein the voxel grid includes a plurality of voxels and each voxel in the voxel grid corresponds to a respective volume in the 3D virtual environment;
computing a respective density value for each voxel based on intersection with geometry in the 3D virtual environment using a physics data structure that represents the geometry;
performing a shortest-path search to determine a path from a first voxel that includes the sound emitter to a second voxel that includes a listener in the 3D virtual environment;
determining an arrival direction for audio emitted by the sound emitter based on a final segment of the path;
adjusting at least one of directional panning or amplitude attenuation of the audio emitted by the sound emitter based on the arrival direction and cumulative density values along the path; and
after the adjusting, rendering the audio at the listener.
